(19) United States
(12) Patent Application Publication
(10) Pub. No.: US 2002/0166941 A1
(43) Pub. Date: Nov. 14, 2002

(54) Seat post

(76) Inventor: Chuck Dunlap, Lakewood, CO (US)

Correspondence Address: DELLETT AND WALTERS, 310 S.W. FOURTH AVENUE, SUITE 1101, PORTLAND, OR, 97204, US

(21) Appl. No.: 10/116,697

(22) Filed: Apr. 3, 2002

Related U.S. Application Data
(60) Provisional application No. 60/281,619, filed on Apr. 4, 2001.

(51) Int. Cl. F16M 13/00; B62J 1/00

(52) U.S. Cl. 248/599; 248/600; 297/195.1; 297/215.14; 280/287

(57) ABSTRACT

A seat post comprises a head with tapered openings therein, and correspondingly tapered wedge members adapted to fit therein. Clamp members cooperate with the wedge members to define seat rail receiving clamps, whereby a through bolt and nut are tightened to secure the seat rail to the head.

### BACKGROUND OF THE INVENTION

This invention relates to seat posts, and more particularly for a seat post for a bicycle or the like for enabling securing of a seat to the bicycle.

### SUMMARY OF THE INVENTION

In accordance with the invention, a seat post assembly includes a head with left and right tapered openings and corresponding tapered wedge members which fit in the head tapers. Clamps cooperate with the wedge members to define seat rail receiving clamps, and a through bolt and nut tightened the head/wedge/clamp structure to secure the seat rail to the head.

Accordingly, it is an object of the present invention to provide an improved seat post.

It is a further object of the present invention to provide an improved seat post which resists rotation.

It is yet another object of the present invention to provide an improved an improved seat post employing tapered wedge parts which resist rotation.

Both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a perspective view of the seat post assembly according to the invention;

FIG. 2 is an end view of the seat post assembly of FIG. 1 taken in the direction of arrow 2 in FIG. 1;

FIG. 3 is a side view of the seat post assembly of FIG. 1 taken in the direction of arrow 3 in FIG. 1;

FIG. 4 is a top view of the seat post assembly of FIG. 1 taken in the direction of arrow 4 in FIG. 1;

FIG. 5 is an exploded perspective view of the seat post assembly of FIG. 1;

FIG. 6 is an exploded view of the seat post assembly of FIG. 2;

FIG. 7 is an exploded side view of the seat post assembly of FIG. 3;

FIG. 8 is an exploded top view of the seat post assembly of FIG. 4;

FIG. 9 is a perspective view of the seat post assembly illustrating seat rails 38 in phantom, showing their cooperation with the wedges and clamps; and

FIG. 10 is a side view showing a seat schematically in a manner as would be mounted to with the seat post clamp.

### DETAILED DESCRIPTION

The system according to a preferred embodiment of the present invention comprises wedge shaped parts that lock into tapered holes, for resisting rotation.

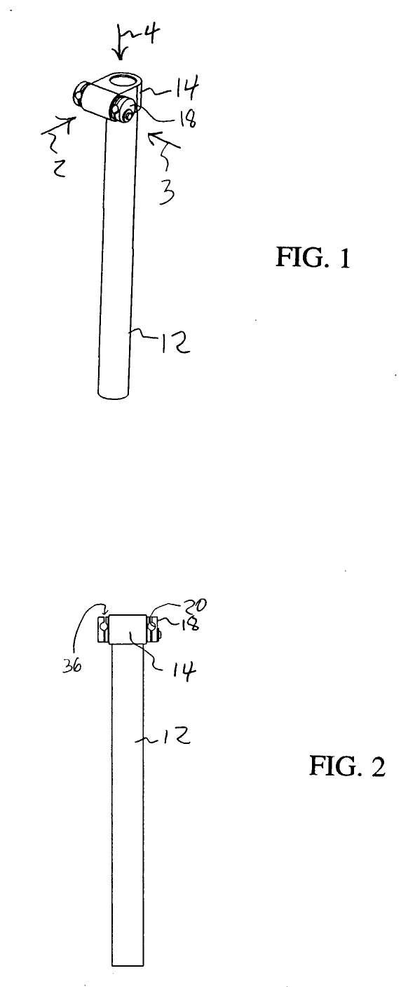

Referring to FIG. 1, a perspective view of the seat post in assembled form and to FIG. 5, an exploded perspective view of the seat post, an elongate tubular post member 12, adapted to be received and secured to a bicycle frame (not shown) for example, has a head 14 secured thereto, typically by gluing or other suitable manner. The head includes an opening 16 that passes therethrough, and which carries an inwardly tapered portion at each side of the opening, being wider at the outermost edge and tapering inwardly and narrower towards the center of the head. A pair of correspondingly tapered wedge members 18 are provided, with the taper of the wedges being such that it cooperates with the taper of the head. A transverse slot 20 is defined in the wider face of the wedge 18, such that the slot faces outwardly when the wedges are installed. A corresponding pair of outer clamp members 22 cooperate with the wedges, the clamp members having transverse slots 24 defined in the inwardly oriented faces thereof. A through bore is defined in the wedges and the clamp members, whereby a bolt 26 may be passed through the clamps, wedges and head, threadably engaging a nut member 28, which may be provided with a seat in the clamp so as to fit flush into the clamp member.

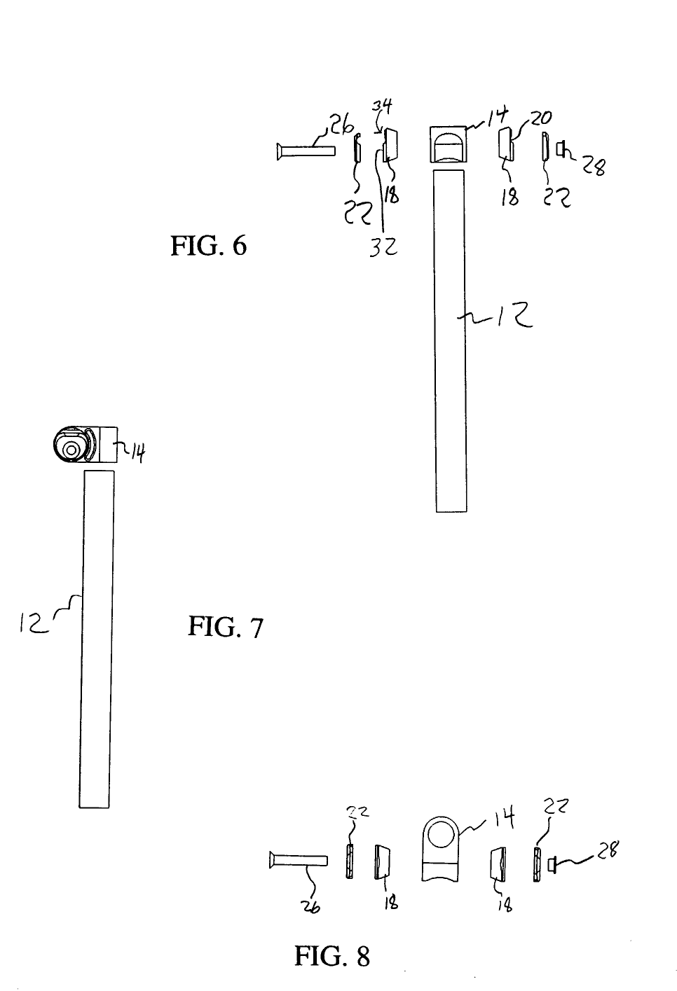

When assembled, from left to right in FIG. 6, the structure comprises the bolt 26, clamp 22, wedge 18, head 14, another wedge 18, another clamp 22 and nut 28. The bolt is suitably tightened, pulling the tapered wedges and clamps together with the head, for secure engagement. The tightening of the through bolt pulls the outer clamps against the seat rails, and pulls the wedges together towards each other. The wedges lock into the tapered hole in the head.

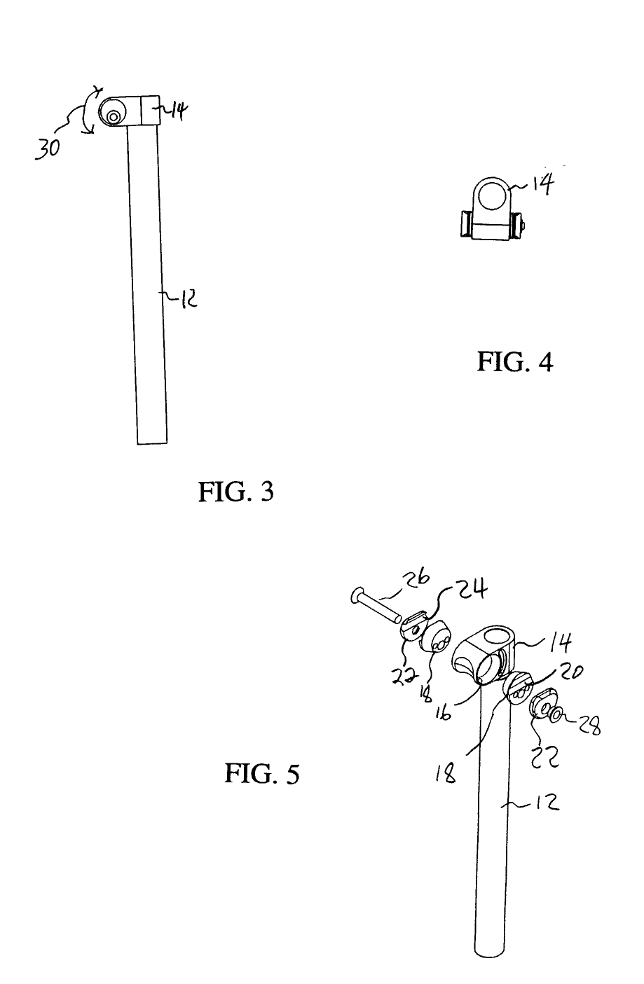

The slots 20 and 24 define receiving openings for the rail of a seat, whereby the clamping action of the wedges and clamp members and the head result in the seat being secured to the head. The assembly is highly resistant to rotation about the arc 30 (FIG. 3). Such rotation is undesirable as it alters the feel of the seat and rider comfort/performance.

Referring again to FIG. 6, it may be noted that the wedges 18 are thicker at a lower portion 32 thereof, while the upper part above the slot 20 is slightly narrower. This allows a slight opening 36 (FIG. 2) between the clamp and wedge, for superior gripping of the seat rail even with rail size variations.

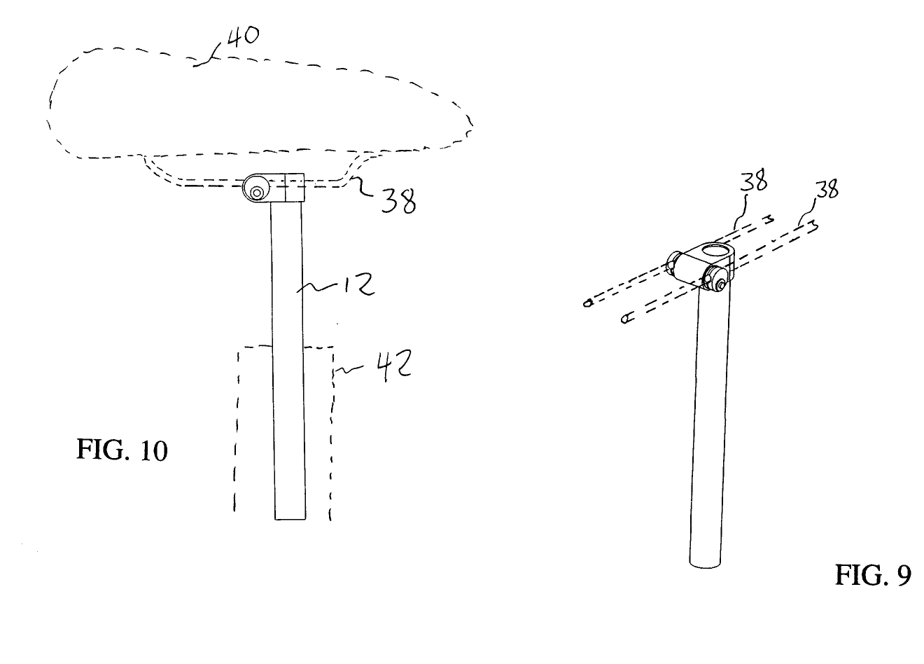

FIGS. 9 and 10 are perspective and side views respectively, illustrating seat rails 38 in phantom, showing their cooperation with the wedges and clamps. A schematic seat 40 is shown in FIG. 10, as an example.

In the preferred embodiment, the seat post clamp is employed in a bicycle. The post 12 is received and suitably secured to the bicycle frame (FIG. 10).

While a preferred embodiment of the present invention has been shown and described, it will be apparent to those skilled in the art that many changes and modifications may be made without departing from the invention in its broader aspects.

What is claimed is:

1. A seat post, comprising:
a head member having a first tapered portion; and
a seat rail receiving wedge member having a second taper, said second taper for cooperating with said first taper to mount said wedge member to said head member.

2. A seat post according to claim 1, further comprising a clamp member adapted to clamp the seat rail to said wedge member.

3. A seat post according to claim 2, further comprising a tightening member for tightening engagement of said clamp member and said wedge member to the seat rail and said wedge member to said head member.

4. A seat post according to claim 3, wherein said tightening member comprises a through bolt passing through said head member, said wedge member and said clamp member, and further comprising a corresponding nut tightening member for cooperating with said through bolt to urge said wedge member against said head member and said clamp member against said wedge member.

5. A seat post according to claim 1, further comprising a tightening member for tightening engagement of said wedge member to said head member.

6. A seat post, comprising:
a head member having at least a first tapered portion; and
first and second seat rail receiving wedge members, at least one of said wedge members having a second taper, said second taper for cooperating with said first taper to mount said wedge members to said head member.

7. A seat post according to claim 5, further comprising first and second clamp members adapted to clamp the seat rail to said wedge members.

8. A seat post according to claim 7, further comprising a tightening member for tightening engagement of said clamp members and said wedge members to the seat rail and said wedge members to said head member.

9. A seat post according to claim 8, wherein said tightening member comprises a through bolt passing through said head member, said wedge members and said clamp members, and further comprising a corresponding nut tightening member for cooperating with said through bolt to urge said wedge members against said head member and said clamp members against said wedge members.

10. A seat post according to claim 5, further comprising a tightening member for tightening engagement of said wedge members to said head member.

11. A bicycle, comprising:
a seat post having a head member, said head member having a first tapered portion; and
a seat rail receiving wedge member having a second taper, said second taper for cooperating with said first taper to mount said wedge member to said head member.

12. A bicycle according to claim 11, further comprising a clamp member adapted to clamp the seat rail to said wedge member.

13. A bicycle according to claim 12, further comprising a tightening member for tightening engagement of said clamp member and said wedge member to the seat rail and said wedge member to said head member.

14. A bicycle according to claim 13, wherein said tightening member comprises a through bolt passing through said head member, said wedge member and said clamp member, and further comprising a corresponding nut tightening member for cooperating with said through bolt to urge said wedge member against said head member and said clamp member against said wedge member.

15. A bicycle according to claim 11, further comprising a tightening member for tightening engagement of said wedge member to said head member.

16. A bicycle according to claim 11, wherein said wedge member comprises first and second wedge portions, wherein said head member includes a second tapered portion, said first and second wedge portions cooperating with said first and second tapered portions.

17. A bicycle according to claim 16, further comprising first and second clamp members adapted to clamp the seat rail to said first and second wedge member portions.
